(19) United States
(12) Patent Application Publication
(10) Pub. No.: US 2026/0070140 A1
(43) Pub. Date: Mar. 12, 2026

(54) DESOLDERING EQUIPMENT

(71) Applicants: Henan Fuchi Technology Co., Ltd., Zhengzhou (CN); HONGFUJIN PRECISION ELECTRONICS (ZHENGZHOU) CO., LTD., Zhengzhou (CN); Fu Tai Hua Industry (Shenzhen) Co., Ltd., Shenzhen (CN); HON HAI PRECISION INDUSTRY CO., LTD., New Taipei (TW)

(72) Inventors: Xue Wang, Zhengzhou (CN); Yi-Xin Zou, Zhengzhou (CN); Jin-Song Zheng, Zhengzhou (CN); Dang-Fei Sun, Zhengzhou (CN); Wen-Long Liu, Zhengzhou (CN); Fu-Xin Jin, Zhengzhou (CN); Wei Liu, Zhengzhou (CN); Bo Ye, Zhengzhou (CN); Quan Liu, Zhengzhou (CN); Dong-Hai Zhou, Zhengzhou (CN); Xi-Qiang Hu, Zhengzhou (CN); Hong-Li He, Zhengzhou (CN)

(21) Appl. No.: 19/273,347

(22) Filed: Jul. 18, 2025

(30) Foreign Application Priority Data
Sep. 12, 2024 (CN) 202411277709.6

(51) Int. Cl. B23K 3/047; B23K 3/08; B23K 101/42

(52) U.S. Cl. CPC B23K 3/047; B23K 3/085; B23K 3/087; B23K 2101/42

(57) ABSTRACT

A desoldering equipment includes a carrier, a conveying assembly, a supporting assembly, a pressing assembly, a laser heating member, and a grabbing assembly. The carrier is configured to position a connecting board and a mainboard. The conveying assembly is configured to convey the carrier to a desoldering position along a first direction. The supporting assembly is arranged under the conveying assembly and configured to position the carrier at the desoldering position. The pressing assembly is arranged above the conveying assembly and configured to press down the mainboard in the carrier at the desoldering position. The laser heating member is configured to heat the connecting board in the carrier at the desoldering position. The grabbing assembly is configured to grab the connecting board on the mainboard pressed down by the pressing assembly and remove the connecting board. The desoldering equipment can remove the connecting board without damaging the mainboard.

### FIELD

The subject matter herein generally relates to a technical field of desoldering, and particularly relates to a desoldering equipment.

### BACKGROUND

The mainboard and the connecting board are connected by solder paste, the mainboard is provided with a circuit system, the circuit system is protected by protective glue, and the connecting board is connected to the area of the mainboard where the circuit system is not provided.

If the connecting board is damaged, it is necessary to remove the damaged connecting board from the mainboard without damaging the mainboard so that the mainboard can be reused. In the related art, a hot air blower is used to heat the connecting board, and the entire connecting board is heated to melt the solder paste, so as to remove the connecting board from the mainboard. However, the above described removal process may easily cause a temperature of the area of the mainboard with the circuit system become too high due to the heat, and the protective glue melts and destroys the circuit system of the mainboard, thereby causing damage to the mainboard.

### BRIEF DESCRIPTION OF THE DRAWINGS

Implementations of the present disclosure will now be described, by way of embodiments, with reference to the attached figures.

FIG. 1 is a schematic diagram of a desoldering equipment according to an embodiment of the present disclosure.

FIG. 2 is a schematic diagram of the desoldering equipment shown in FIG. 1, without an operating box.

FIG. 3 is a schematic diagram illustrating a pressing member pressing a mainboard to be disassembled toward a carrier according to an embodiment of the present disclosure.

FIG. 4 is an exploded view illustrating a pressing member, a mainboard, and a carrier according to an embodiment of the present disclosure.

FIG. 5 is a partial exploded view of a desoldering equipment according to an embodiment of the present disclosure.

FIG. 6 is a schematic diagram of a pressing assembly and a grabbing assembly according to an embodiment of the present disclosure.

FIG. 7 is a schematic diagram of a grabbing assembly according to an embodiment of the present disclosure.

FIG. 8 is a schematic diagram of a supporting assembly according to an embodiment of the present disclosure.

### DETAILED DESCRIPTION

The following will describe the technical solutions in the embodiments of the present disclosure in conjunction with the drawings in the embodiments of the present disclosure. Obviously, the described embodiments are only part of the embodiments of the present disclosure, not all of the embodiments.

It should be noted that when an element is considered to be “connected” to another element, it can be directly connected to another element or there may be a centrally arranged element at the same time. When an element is considered to be “set” on another element, it can be directly set on another element or there may be a centrally arranged element at the same time. In this disclosure, unless otherwise clearly specified and limited, the terms “installed”, “connected”, “connected”, “fixed” and the like should be understood in a broad sense. For ordinary technicians in this field, the specific meanings of the above terms in this disclosure can be understood according to the specific circumstances.

Unless otherwise defined, all technical and scientific terms used in this article have the same meaning as those generally understood by technicians in the technical field of this disclosure. The terms used in this article in the specification of this disclosure are only for the purpose of describing specific embodiments and are not intended to limit this disclosure.

In the description of the embodiments of the present disclosure, the technical terms “first”, “second” and the like are only used to distinguish different objects, and cannot be understood as indicating or implying relative importance or implicitly indicating the number, specific order or primary and secondary relationship of the indicated technical features. In the description of the embodiments of the present disclosure, “multiple” means more than two, unless otherwise clearly and specifically defined.

In the description of the embodiments of the present disclosure, the term “vertical” is used to describe the ideal state between two components. In the actual production or use state, there may be a state that is approximately perpendicular between the two components. The two components described as “vertical” may not be absolute straight lines or planes, but may be roughly straight lines or planes. From a macroscopic point of view, the components can be considered as “straight lines” or “planes” if the overall extension direction is a straight line or plane.

The term “parallel” is used to describe the ideal state between two components. In the actual production or use state, there may be a state that is approximately parallel between the two components. The two components described as “parallel” may not be absolute straight lines or planes, but may be roughly straight lines or planes. From a macroscopic point of view, the components can be considered as “straight lines” or “planes” if the overall extension direction is a straight line or plane.

The reference to “embodiment” in this article means that the specific features, structures or characteristics described in conjunction with the embodiment may be included in at least one embodiment of the present disclosure. The appearance of this phrase in various places in the specification does not necessarily refer to the same embodiment, nor is it an independent or alternative embodiment that is mutually exclusive with other embodiments. In the absence of conflict, the various embodiments in this disclosure can be combined with each other.

It should be noted that the thickness, length, width and other dimensions of various components in the embodiments of this disclosure shown in the drawings, as well as the overall thickness, length, width and other dimensions of the integrated desoldering device are only exemplary and should not constitute any limitation to this disclosure.

A mainboard and a connecting board are connected by solder paste. The mainboard is provided with a circuit system, which is protected by protective glue. The connecting board is connected to an area of the mainboard where the circuit system is not provided. If the connecting board is damaged, it is necessary to remove the damaged connecting board from the mainboard without damaging the mainboard to achieve the reuse of the mainboard. In the related art, a hot air blower is used to heat the connecting board, and the entire connecting board is heated to melt the solder paste so that the connecting board can be removed from the mainboard, which easily causes a temperature of the area of the mainboard with the circuit system to be too high due to the heat, and the protective glue melts and destroys the circuit system of the mainboard, thereby causing damage to the mainboard.

An embodiment of the present disclosure provides a desoldering equipment for removing a connecting board connected to a mainboard, and the desoldering equipment includes a carrier, a conveying assembly, a supporting assembly, a pressing assembly, a laser heating member, and a grabbing assembly. The carrier is used to position the connecting board and the mainboard. The conveying assembly is used to convey the carrier to a desoldering position along a first direction. The supporting assembly is arranged under the conveying assembly and used to position the carrier at the desoldering position. The pressing assembly is arranged above the conveying assembly and used to press down the mainboard in the carrier at the desoldering position. The laser heating member is used to heat the connecting board in the carrier at the desoldering position. The grabbing assembly is used to grab the connecting board on the mainboard pressed down by the pressing assembly, so as to remove the connecting board.

In the above-mentioned desoldering equipment, the carrier is driven to move to the desoldering position by the conveying assembly, and the carrier is positioned at the desoldering position by the supporting assembly, the pressing assembly presses the mainboard against the carrier to fix the mainboard, so that the mainboard is fixed when the grabbing assembly grabs the connecting board heated by the laser heating member, and the connecting board is removed from the mainboard; the laser heating member can heat the connecting board section by section according to a preset path, which can prevent the area of the mainboard where the circuit system is provided from being damaged due to excessive temperature caused by heat, so as to remove the connecting board connected to the mainboard or the desoldering equipment that connects the mainboard to the connecting board without damaging the mainboard, thereby realizing the reuse of the mainboard.

The following is a further description of the embodiments of the present disclosure in conjunction with the accompanying drawings.

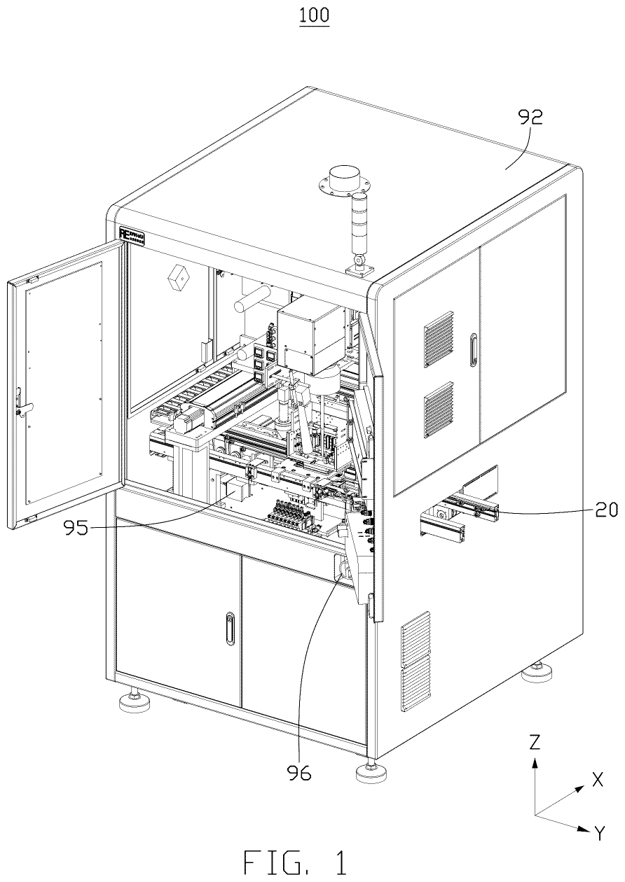

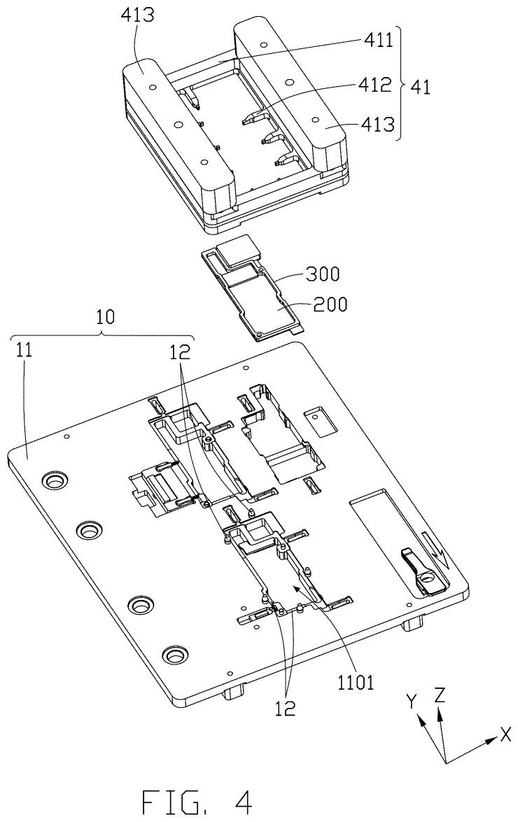

Referring to FIG. 1, an embodiment of the present disclosure provides a desoldering equipment 100. The desoldering equipment 100 is used to remove the connecting board 300 connected to the mainboard 200 (referring to FIG. 4).

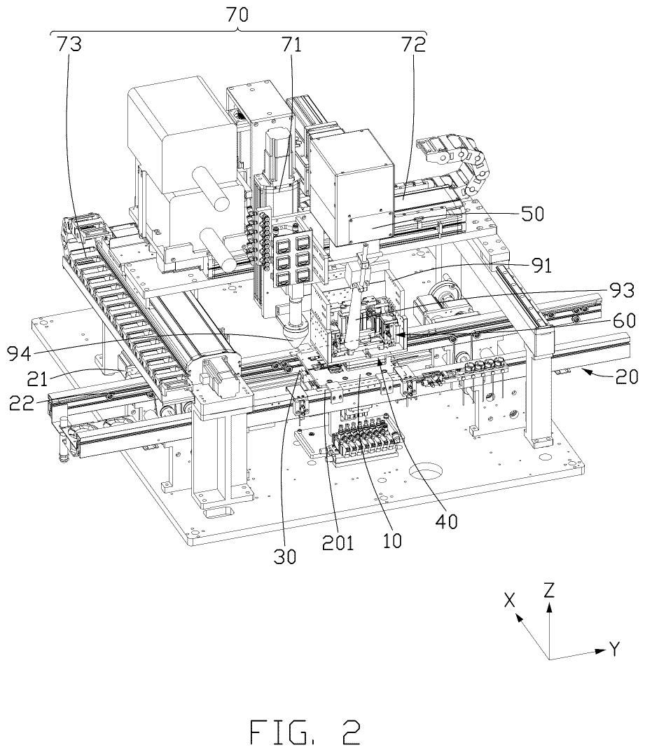

Referring to FIG. 2, in some embodiments, the desoldering equipment 100 includes a carrier 10, a conveying assembly 20, a supporting assembly 30, a pressing assembly 40, a laser heating member 50, and a grabbing assembly 60.

The carrier 10 is used to position the connecting board 300 and the mainboard 200. The conveying assembly 20 is used to convey the carrier 10 along a first direction. The conveying assembly 20 has a desoldering position 201, and the conveying assembly 20 is used to move the carrier 10 to the desoldering position 201 or move the carrier 10 out of the desoldering position 201. The supporting assembly 30 is arranged below the desoldering position 201 of the conveying assembly 20 and used to position the carrier 10 at the desoldering position 201. The pressing assembly 40 is arranged above the conveying component 20 and used to press down the mainboard 200 in the carrier 10 located at the desoldering position 201. The laser heating member 50 can heat the connecting board 300 in the carrier 10 located at the desoldering position 201 section by section according to a preset path. The grabbing assembly 60 is disposed above the desoldering position 201 and used to grab the connecting board 300 on the mainboard 200 pressed down by the pressing assembly 40, and remove the connecting board 300.

When the connecting board 300 connected to the mainboard 200 needs to be removed, the conveying assembly 20 moves the carrier 10 to the desoldering position 201, the supporting assembly 30 positions the carrier 10 at the desoldering position 201, and the pressing assembly 40 presses the mainboard 200 at the desoldering position 201 against the carrier 10. At this time, the grabbing assembly 60 grabs the connecting board 300 heated by the laser heating member 50 and removes the connecting board 300 from the mainboard 200. The laser heating member 50 can heat the connecting board 300 section by section according to a preset path, which can prevent the area of the mainboard 200 where the circuit system is provided from being damaged due to excessive temperature caused by heat, so that the connecting board 300 connected to the mainboard 200 can be removed without damaging the mainboard 200, and the undamaged mainboard 200 can be reused, which greatly saves costs.

When the connecting board 300 needs to be connected to the mainboard 200, the conveying assembly 20 moves the carrier 10 to the desoldering position 201, the supporting assembly 30 positions the carrier 10 at the desoldering position 201, and the pressing assembly 40 presses the connecting board 300 in the carrier 10 against the mainboard 200, so that the connecting board 300 and the mainboard 200 are connected after being heated by the laser heating member 50. The laser heating member 50 can heat the connecting board 300 section by section according to a preset path, which can prevent the area of the main board 200 where the circuit system is provided from being damaged due to excessive temperature caused by heat, so that the mainboard 200 is connected to the connecting board 300 without damaging the mainboard 200, so as to reduce the damage rate of the mainboard 200.

In some embodiments, the connecting board 300 may be connected to an area of the mainboard 200 where the circuit system is not provided.

In some embodiments, the laser heating member 50 may be a laser heater. The energy of the laser heater is concentrated. Compared with the traditional hot air gun, when the traditional hot air gun heats the connecting board 300, the heat source is easy to radiate to the surroundings, so that the area of the mainboard 200 where the circuit system is provided is easily affected by the heat radiation, resulting in a temperature rise and causing damage to the mainboard 200. The laser heater can concentrate the heat source on the connecting board 300, which can effectively reduce the phenomenon of the heat source radiating to the surroundings. When the laser heater is used to heat the connecting board 300 according to the preset path, the area of the mainboard 200 where the circuit system is provided is not easily affected by the heat radiation and the temperature of the area of the mainboard 200 where the circuit system is provided does not easily rise, the circuit system of the mainboard 200 is not easily damaged by high temperature, and the mainboard 200 is not easily damaged.

In some embodiments, the preset path may be the same shape as the connecting board 300.

In the illustrated embodiment, the first direction may be parallel to the Y axis.

In some embodiments, the desoldering equipment 100 may further include a transfer assembly 70. The transfer assembly 70 is used to move the pressing assembly 40, the laser heating member 50 and the grabbing assembly 60, so that the pressing assembly 40, the laser heating member 50 and the grabbing assembly 60 can be moved to above the desoldering position 201, thereby operating the mainboard 200 or the connecting board 300 at the desoldering position 201.

In some embodiments, the desoldering equipment 100 may further include a bracket 91. The bracket 91 is connected to the transfer assembly 70, and the bracket 91 is used to connect the pressing assembly 40 and the grabbing assembly 60, so that the transfer assembly 70 can move the pressing assembly 40 and the grabbing assembly 60 simultaneously by driving the bracket 91 to move.

In some embodiments, the transfer assembly 70 may include a first moving member 71. The first moving member 71 is connected to the bracket 91 and used to drive the bracket 91 to move in a vertical direction, so that the bracket 91 drives the grabbing assembly 60 and the pressing assembly 40 to move in the vertical direction simultaneously. When the pressing assembly 40 presses the mainboard 200 against the carrier 10, the grabbing assembly 60 can grab the connecting board 300, so that the grabbing assembly 60 separates the connecting board 300 from the mainboard 200.

In some embodiments, the first moving member 71 may be a lifting cylinder.

In some embodiments, the transfer assembly 70 may further include a second moving member 72 and a third moving member 73. The second moving member 72 is used to connect the first moving member 71 and the laser heating member 50, and the second moving member 72 is used to drive the bracket 91 and the laser heating member 50 to move along the first direction, so that the bracket 91 and the laser heating member 50 can move along the first direction. The third moving member 73 is connected to the second moving member 72 and used to drive the second moving member 72 to move along a second direction, so that the bracket 91 and the laser heating member 50 can move along the second direction.

In the illustrated embodiment, the second direction may be parallel to the X-axis. The second direction and the first direction are two horizontal directions perpendicular to each other.

The second moving member 72 and the third moving member 73 can adjust the position of the bracket 91 and the laser heating member 50 in the horizontal direction, so that the grabbing assembly 60, the pressure assembly 40 and the laser heating member 50 can all be moved to above the desoldering position 201. Therefore, when the pressing assembly 40 presses down the mainboard 200 in the carrier 10 located at the desoldering position 201, the grabbing assembly 60 can grab the connecting board 300 in the carrier 10 located at the desoldering position 201, and the laser heating member 50 can heat the connecting board 300 in the carrier 10 located at the desoldering position 201.

In some embodiments, the second moving member 72 and the third moving member 73 may be both linear slide rails.

In some embodiments, the conveying assembly 20 may include multiple sections of belts 22 and multiple power members 21. The multiple sections of belts 22 are connected in sequence along the first direction, and each section of the multiple sections of belts 22 is driven by a respective one of the multiple power members 21. The desoldering position 201 is located in one of the multiple sections of belts 22.

In some embodiments, the conveying assembly 20 may include three sections of belts 22. A position corresponding to a section of belt 22 located in the middle of the three sections of belts 22 is the desoldering position 201, and each of the multiple power members 21 controls a respective one of the three sections of belts 22 to work, so that the carrier 10 can slow down or stop moving when it is moved to the desoldering position 201, which facilitate the supporting assembly 30 to position the carrier 10 at the desoldering position 201. In addition, when the supporting assembly 30 positions the carrier 10 at the desoldering position 201, the remaining two belts 22 of the three sections of belts 22 can continue to work to unload the mainboard 200 removed from the desoldering position 201, or move the mainboard 200 and the connecting board 300 to be disassembled to the desoldering position 201 for loading preparation, thereby improving the efficiency of loading and unloading.

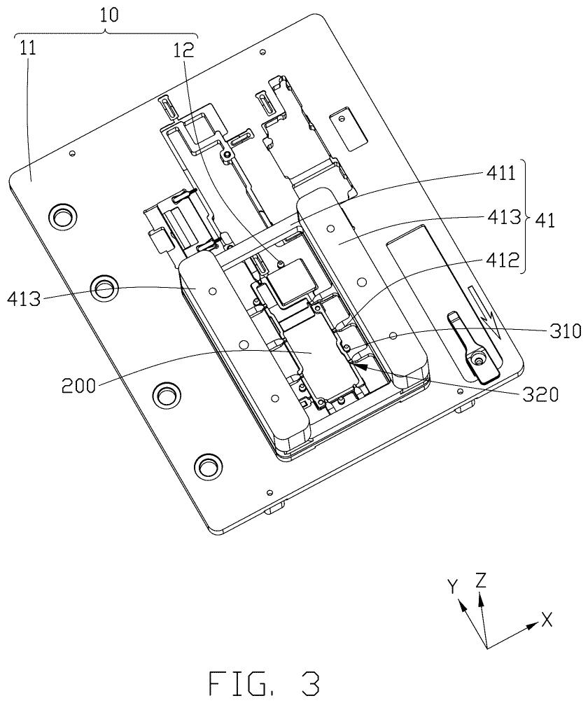

Referring to FIGS. 3 and 4, in some embodiments, the carrier 10 may include a flat plate 11 and a plurality of positioning pins 12. The flat plate 11 is used to carry the mainboard 200 and the connecting board 300. The plurality of positioning pins 12 are arranged on the flat plate 11. When the carrier 10 carries the mainboard 200 and the connecting board 300, the plurality of positioning pins 12 are located on a side of the flat plate 11 where the mainboard 200 and the connecting board 300 are provided, and distributed around the mainboard 200 and the connecting board 300, so as to position the mainboard 200 and the connecting board 300, thereby preventing the mainboard 200 and the connecting board 300 from shifting in the horizontal direction.

In some embodiments, the carrier 10 may have an opening 1101. The opening 1101 penetrates the flat plate 11. When the connecting board 300 and the mainboard 200 are positioned on the carrier 10, the area where the mainboard 200 is provided with the circuit system is located at the opening 1101, so that an area where the mainboard 200 is not connected to the connecting board 300 has better heat dissipation performance, which can prevent the area where the mainboard 200 is provided with the circuit system from being damaged due to excessive temperature, thereby preventing damage to the mainboard 200.

In some embodiments, the mainboard 200 may be applied to a mobile phone or other electronic products.

In some embodiments, the mainboard 200 may be connected to the connecting board 300 by solder paste, and the solder paste can melt under the action of high temperature.

The desoldering equipment 100 can be used to connect the mainboard 200 and the connecting board 300, and can also remove the connecting board 300 connected to the mainboard 200 from the mainboard 200. A side of the connecting board 300 to be installed close to the mainboard 200 to be installed is provided with solder paste. The connecting board 300 to be removed has the same shape as the connecting board 300 to be installed.

When the connecting board 300 connected to the mainboard 200 is to be removed: first, the connecting board 300 to be disassembled is cut into a plurality of scrap segments 310, and the scrap segments 310 are all connected to the mainboard 200 to be disassembled, and a gap 320 is formed between any two adjacent scrap segments 310 (as shown in FIG. 3). Then, the connecting board 300 to be disassembled and the mainboard 200 to be disassembled are positioned on the carrier 10, and are moved to the desoldering position 201 with the carrier 10 for disassembly under the drive of the conveying assembly 20, and the solder paste is sandwiched between the mainboard 200 to be disassembled and the connecting board 300 to be disassembled. After the pressing assembly 40 presses the mainboard 200 to be disassembled against the carrier 10, the laser heating member 50 heats the scrap segment 310 according to a preset path to melt the solder paste, and the grabbing assembly 60 grabs the heated scrapped section 310 and separates the scrap segment 310 from the mainboard 200 to be disassembled. Each time the laser heating member 50 heats a scrapped section 310, the grabbing assembly 60 removes a scrap segment 310 from the mainboard 200 to be disassembled. Repeating the operation can remove the connecting board 300 to be disassembled from the mainboard 200 to be disassembled, so as to remove the connecting board 300 from the mainboard 200.

In some embodiments, when the connecting board 300 is removed from the mainboard 200, solder paste may remain on the mainboard 200. The mainboard 200 removes the solder paste remaining on the mainboard 200 through a tin removal device. The mainboard 200 after the solder paste is removed can be reused to connect with the connecting board 300 to achieve the reuse of the mainboard 200.

In some embodiments, a cutting device is used to cut the connecting board 300 to be disassembled into a plurality of scrap segments 310. As an exemplary example, the cutting device may be a laser cutting machine.

When the connecting board 300 is to be connected to the mainboard 200: first, the mainboard 200 to be installed and the connecting board 300 to be installed are sequentially stacked and positioned on the carrier 10, and then moved to the soldering position 201 for installation under the drive of the conveying assembly 20. The pressing assembly 40 presses the connecting board 300 to be installed against the mainboard 200 to be installed, with the solder paste sandwiched between the connecting board 300 to be installed and the mainboard 200 to be installed. The laser heating member 50 heats the connecting board 300 to be installed to melt the solder paste. After the melted solder paste cools down, it connects the mainboard 200 to be installed and the connecting board 300 to be installed together, thereby achieving the connection between the connecting board 300 and the mainboard 200.

Referring to FIGS. 2 to 4, in some embodiments, the pressing assembly 40 may include a pressing member 41, and the pressing member 41 includes a frame 411 and multiple pressing blocks 412. The multiple pressing blocks 412 are connected to the frame 411 and extend towards an inner side of the frame 411. Please referring to FIG. 3, when the connecting board 300 connected to the mainboard 200 is to be removed, the multiple pressing blocks 412 are used to pass through notches 320 and press down the mainboard 200 to be removed, thereby pressing the mainboard 200 to be removed against the carrier 10. Referring to FIG. 4, when the connecting board 300 is to be connected to the mainboard 200, the multiple pressing blocks 412 are also used to press down the connecting board 300 to be installed, thereby pressing the connecting board 300 to be installed against the mainboard 200 to be installed.

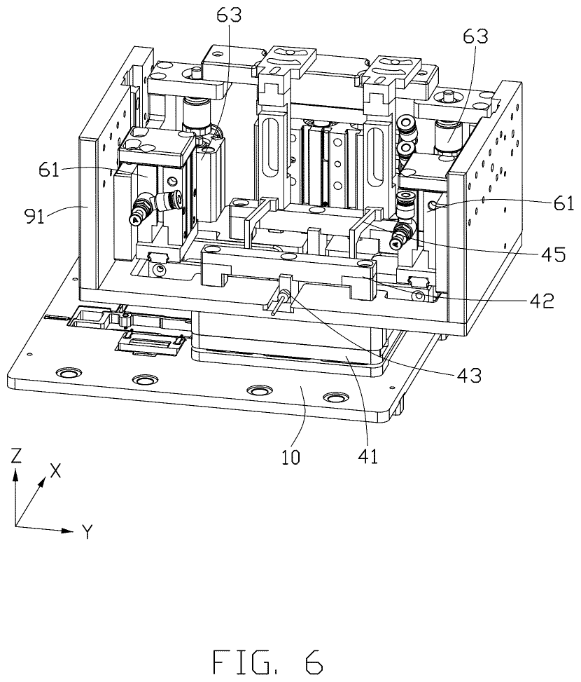

Referring to FIG. 6, in some embodiments, the pressing member 41 is arranged at a bottom of the bracket 91, thereby allowing the pressing member 41 to move towards the carrier 10 with the bracket 91 under the drive of the transfer assembly 70.

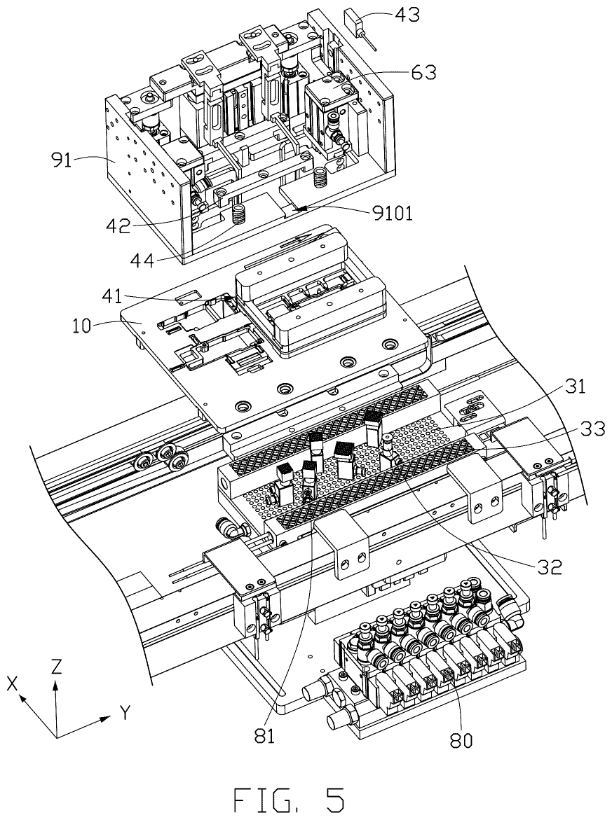

Referring to FIGS. 5 and 6, in some embodiments, the bracket 91 may define a through groove 9101, and the pressing assembly 40 may further include a stopper 42 and a sensing member 43. The stopper 42 is arranged on a side of the bracket 91 facing away from the pressing member 41. The sensing member 43 is connected to the stopper 42 and extends through the through groove 9101.

In some embodiments, the pressing member 41 may further include two spacer blocks 413. The frame 411 is connected to the bottom of the bracket 91 through the two spacer blocks 413, and the two spacer blocks 413 are spaced apart in the second direction to increase a distance between the bottom of the bracket 91 and the carrier 10, thereby facilitating the connection of the stopper 42 and the sensing member 43.

The pressing member 41 is moved toward the carrier 10 with the bracket 91 through the transfer assembly 70. When the pressing member 41 presses down the mainboard 200 to be disassembled or the connecting board 300 to be installed, the pressing member 41 applies force to the sensing member 43 toward the stopper 42. In this way, the sensing member 43 can sense the interaction force between the pressing member 41 and the stopper 42, thereby judging that the pressing member 41 has pressed the mainboard 200 to be disassembled against the carrier 10, or pressed the connecting board 300 to be installed against the mainboard 200 to be installed, so as to prevent the mainboard 200 or the connecting board 300 from being damaged due to excessive pressure when the pressing member 41 presses down the mainboard 200 to be disassembled or the connecting board 300 to be installed. When the sensing member 43 senses that the pressing member 41 presses the mainboard 200 to be disassembled against the carrier 10, the laser heating member 50 can heat the connecting board 300 to be installed according to a preset path.

In some embodiments, the sensing member 43 may be a pressure sensor.

In some embodiments, there are two stoppers 42, two through grooves 9101 and two sensing members 43, each of the two stoppers 42 is connected to a respective one of the sensing members 43, each of the two slots 9101 accommodates a respective one of the sensing members 43, and the two stoppers 42 are arranged at intervals along the second direction. The two sensing members 43 sense whether the pressing member 41 applies pressure to the mainboard 200 to be disassembled or the connecting board 300 to be installed, so that the judgment result is more accurate.

Referring to FIG. 5, in some embodiments, the pressing assembly 40 may further include an elastic member 44. The elastic member 44 is connected between the stopper 42 and the bracket 91. When the pressing member 41 applies force to the sensing member 43 toward the stopper 42, the elastic member 44 elastically stretches to buffer the sensing member 43, which can prevent the pressing member 41 from applying excessive force to the sensing member 43 and damaging the sensing member 43.

In some embodiments, the pressing member 41 applies force to the sensing member 43 toward the stopper 42 through the spacer block 413.

Referring to FIGS. 5 to 7, in some embodiments, the pressing assembly 40 may further include a pressing rod 45, and the pressing rod 45 is connected to the bracket 91. The pressing rod 45 is used to press down the mainboard 200. When the transfer assembly 70 drives the pressing member 41 to move toward the carrier 10 with the bracket 91, the pressing rod 45 presses the mainboard 200 against the carrier 10 to fix the mainboard 200 to be installed and the mainboard 200 to be disassembled.

In some embodiments, there are two pressing rods 45 arranged at intervals along the first direction, and the two pressure rods 45 can more stably press the mainboard 200 against the carrier 10.

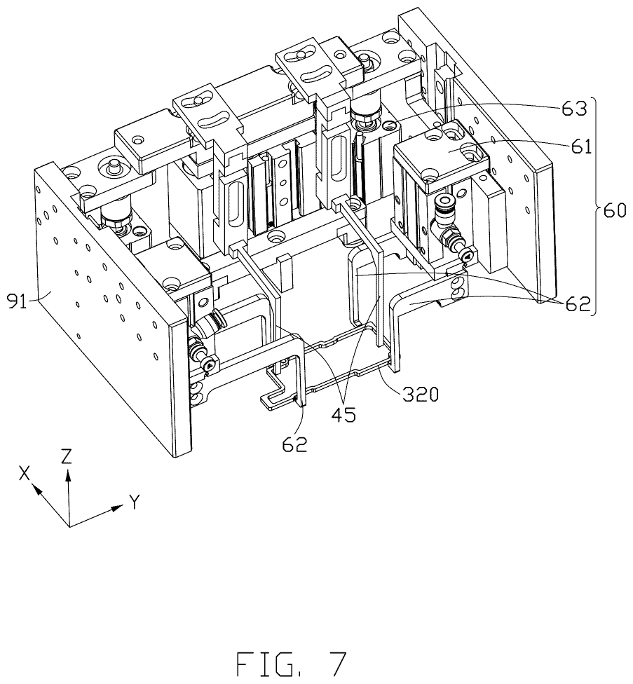

Referring to FIGS. 6 and 7, in some embodiments, the grabbing assembly 60 includes a driving member 61, an adjusting member 63 and two clamps 62. The driving member 61 connects the two clamps 62 to drive the two clamps 62 to move toward each other and clamp the scrap segment 310. The adjusting member 63 is connected to the bracket 91. The adjusting member 63 is connected to the driving member 61. The adjusting member 63 is used to drive the driving member 61 and drive the two clamps 62 to move in the vertical direction, so that the two clamps 62 can grab the scrap segment 310 to rise, so that the scrap segment 310 can be separated from the mainboard 200 to be disassembled.

In some embodiments, there are two groups of grabbing assemblies 60. The two groups of grabbing assemblies 60 are arranged at intervals along the first direction to grab the scrap segments 310 on both sides.

In some embodiments, the adjusting member 63 may be a lifting cylinder. The driving member 61 may be a clamping claw cylinder.

In some embodiments, the pressing rod 45 may be connected to the adjusting member 63, so that the pressing rod 45 can rise or fall with the grabbing assembly 60 under the adjustment of the adjusting member 63.

In the illustrated embodiment, the vertical direction is parallel to the Z axis.

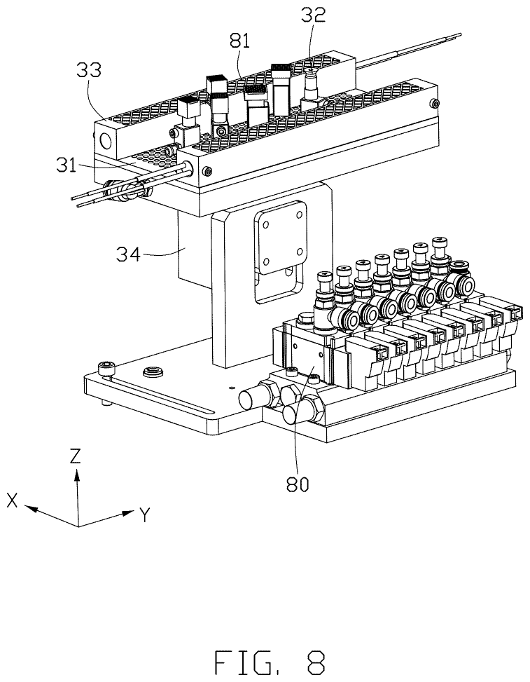

Referring to FIGS. 5 and 8, in some embodiments, the supporting assembly 30 includes a porous plate 31, a suction cup 32 and two preheating tables 33. The two preheating stations 33 are arranged on the porous plate 31 along the second direction. The two preheating stations 33 are used to carry and preheat the carrier 10, so that the area of the mainboard 200 used for connecting with the connecting board 300 can be preheated by the preheating stations 33, so that the area of the connecting board 300 connected to the mainboard 200 can be heated faster under the heating of the laser heating member 50, which is conducive to the melting of the solder paste. The suction cup 32 is arranged on the porous plate 31 and located between the two preheating stations 33. The suction cup 32 is used to absorb the carrier 10, so that the carrier 10 can be absorbed and fixed by the suction cup 32, so that the supporting assembly 30 connects the carrier 10.

In some embodiments, the supporting assembly 30 may further include a lifting member 34, the lifting member 34 is connected to the porous plate 31, and the lifting member 34 is used to lift the porous plate 31 in the vertical direction to position the carrier 10 at the desoldering position 201, and move the carrier 10 upward to separate from the conveying assembly 20. The lifting member 34 is also used to lower the porous plate 31 in the vertical direction, so that the carrier 10 is separated from the porous plate 31 and falls to the conveying assembly 20, and the conveying assembly 20 is used to carry and output the carrier 10 in the first direction after the porous plate 31 is lowered.

In some embodiments, the lifting member 34 may be a lifting cylinder.

In some embodiments, the desoldering equipment 100 may further include an air cooling module 80. The air cooling module 80 is used to blow air toward the porous plate 31. The air blown by the air cooling module 80 passes through the porous plate 31 and the opening 1101 and acts on the mainboard 200 to cool down the area where the circuit system of the mainboard 200 is provided, thereby preventing the area where the circuit system of the mainboard 200 is provided from being damaged due to excessive temperature, thereby preventing damage to the mainboard 200. In addition, the preheating stations 33 can also stop the air cooling module 80 from cooling down the area of the mainboard 200 used to connect with the connecting board 300, thereby preventing the air cooling module 80 from affecting the heating of the connecting board 300 by the laser heating member 50.

In some embodiments, the air cooling module 80 includes a blowing member 81. The blowing member 81 is arranged on the porous plate 31. The blowing member 81 is used to blow air toward the area of the mainboard 200 where the circuit system is provided through the opening 1101 to cool down the area of the mainboard 200 where the circuit system is provided, thereby preventing the circuit system of the mainboard 200 from being damaged by high temperature.

In some embodiments, the air cooling module 80 may be controlled by a control module.

In some embodiments, the desoldering equipment 100 may further include a thermal imager 93. The thermal imager 93 is connected to the bracket 91. The thermal imager 93 is used to detect a temperature of the mainboard 200 or a temperature of the connecting board 300. The laser heating member 50 starts or stops heating, or adjusts the heating temperature according to a detection result of the thermal imager 93.

In some embodiments, the desoldering equipment 100 may further include an image sensing member 94, which is used to capture a movement of the carrier 10 to capture a position of the carrier 10. After the image sensing component 94 captures that the carrier 10 is positioned at the desoldering position 201, the transfer assembly 70 drives the bracket 91 to move vertically downward, so that the pressing assembly 40 and the grabbing assembly 60 can act on the mainboard 200 or the connecting board 300 on the carrier 10. As an exemplary example, the image sensing component 94 may be a CCD camera.

Referring to FIG. 1, in some embodiments, the desoldering equipment 100 may further include a code scanning member 95, and the code scanning member 95 is arranged on a side of the conveying assembly 20. The code scanning member 95 is used to identify the mainboard 200 so as to enter data of the mainboard 200 entering the conveying assembly 20. As an exemplary example, the code scanning component 95 may be a code scanning gun.

The desoldering equipment 100 may further include an operating box 92, and the conveying assembly 20, the supporting assembly 30, the pressing assembly 40, the laser heating member 50, the grabbing assembly 60, the transfer assembly 70, the thermal imager 93, and the image sensing member 94 are all installed in the operating box 92. The conveying assembly 20 extends through the operating box 92 along the first direction and two ends of the conveying assembly 20 are located outside the operating box 92, so that the carrier 10 can drive the mainboard 200 and the connecting board 300 to be loaded and unloaded.

A front side of the operating box 92 has a visual window, through which an interior of the operating box can be observed. The front side of the operating box 92 is also provided with a power switch 96 to control a total power supply of the desoldering equipment 100.

The above is only a specific implementation of the present disclosure, but the protection scope of the present disclosure is not limited thereto. Any changes or replacements within the technical scope disclosed in the present disclosure should be included in the disclosure scope of the present disclosure.

What is claimed is:

1. A desoldering equipment configured for removing a connecting board connected to a mainboard, the desoldering equipment comprising:
a carrier configured to position the connecting board and the mainboard;
a conveying assembly configured to convey the carrier to a desoldering position along a first direction;
a supporting assembly arranged under the conveying assembly and configured to position the carrier at the desoldering position;
a pressing assembly arranged above the conveying assembly and configured to press down the mainboard in the carrier at the desoldering position;
a laser heating member configured to heat the connecting board in the carrier at the desoldering position; and
a grabbing assembly configured to grab the connecting board on the mainboard pressed down by the pressing assembly and remove the connecting board.

2. The desoldering equipment of claim 1, wherein the pressing assembly comprises a pressing member, the pressing member comprises a frame and multiple pressing blocks, the multiple pressing blocks are connected to the frame and extend towards an inner side of the frame, each of the multiple pressing blocks is configured to extend through the connecting board and press down the mainboard to be removed.

3. The desoldering equipment of claim 2, wherein the desoldering equipment further comprises a bracket, the pressing member is arranged at a bottom of the bracket, the bracket comprises a through groove, the pressing assembly further comprises a stopper and a sensing member, the stopper is arranged on a side of the bracket facing away from the pressing member, the sensing member is connected to the stopper and extends through the through groove, the pressing assembly is configured to apply force to the sensing member toward the stopper when the pressing member presses down the mainboard to be removed or the connecting board to be installed.

4. The desoldering equipment of claim 3, wherein the pressing assembly further comprises an elastic member, and the elastic member is connected between the stopper and the bracket, the elastic member is configured to elastically stretch to buffer the sensing member when the pressing member applies force to the sensing member toward the stopper.

5. The desoldering equipment of claim 1, wherein the supporting assembly comprises a porous plate and a suction cup, the suction cup is arranged on the porous plate and configured to absorb the carrier.

6. The desoldering equipment of claim 5, wherein the supporting assembly further comprises two preheating tables, the preheating tables are arranged on the porous plate along a second direction and configured to carry and preheat the carrier, the suction cup is located between the preheating tables, the second direction and the first direction are two horizontal directions perpendicular to each other.

7. The desoldering equipment of claim 5, wherein the supporting assembly further comprises a lifting member, the lifting member is connected to the porous plate and configured to lift the porous plate in a vertical direction to position the carrier at the desoldering position or lower the porous plate in the vertical direction, the conveying assembly is configured to carry and output the carrier in the first direction after the porous plate is lowered.

8. The desoldering equipment of claim 6, wherein the supporting assembly further comprises a lifting member, the lifting member is connected to the porous plate and configured to lift the porous plate in a vertical direction to position the carrier at the desoldering position or lower the porous plate in the vertical direction, the conveying assembly is configured to carry and output the carrier in the first direction after the porous plate is lowered.

9. The desoldering equipment of claim 6, wherein the desoldering equipment further comprises an air cooling module, the air cooling module is configured to blow air toward the porous plate to cool down an area of the mainboard where a circuit system is provided.

10. The desoldering equipment of claim 9, wherein the carrier comprises an opening, the opening is configured to pass the air blown from the air cooling module to cool down the area of the mainboard where a circuit system is provided.

11. The desoldering equipment of claim 8, wherein the desoldering equipment further comprises an air cooling module, the air cooling module is configured to blow air toward the porous plate to cool down an area of the mainboard where a circuit system is provided.

12. The desoldering equipment of claim 11, wherein the carrier comprises an opening, the opening is configured to pass the air blown from the air cooling module to cool down the area of the mainboard where a circuit system is provided.

13. The desoldering equipment of claim 1, wherein the grabbing assembly comprises a driving member, an adjusting member and two clamps, the driving member connects the two clamps, the driving member is configured to drive the two clamps to move toward each other, the two clamps are configured to clamp the connecting board, the adjusting member is connected to the driving member and configured to drive the two clamps to move in a vertical direction.

14. The desoldering equipment of claim 1, wherein the conveying assembly comprises multiple sections of belts and multiple power members, the multiple sections of belts are connected in sequence along the first direction, each of the multiple power members is configured to drive a respective one section of the multiple sections of belts.

15. The desoldering equipment of claim 3, wherein the pressing assembly further comprises a pressing rod connected to the bracket, the pressing rod is configured to press down the mainboard.

16. The desoldering equipment of claim 3, wherein the desoldering equipment further comprises a transfer assembly, the transfer assembly comprises a first moving member, a second moving member, and a third moving member, the first moving member is connected to the bracket and configured to drive the bracket to move in a vertical direction, the bracket is configured to connect the pressing assembly and the grabbing assembly to allow the pressing assembly and the grabbing assembly to move towards the desoldering position simultaneously, the second moving member is configured to connect the first moving member and the laser heating member and configured to drive the bracket and the laser heating member to move along the first direction, the third moving member is connected to the second moving member and configured to drive the second moving member to move along a second direction.

17. The desoldering equipment of claim 1, wherein the desoldering equipment further comprises a thermal imager, the thermal imager is connected to the bracket and configured to detect a temperature of the mainboard or a temperature of the connecting board.

18. The desoldering equipment of claim 1, wherein the desoldering equipment further comprises an image sensing member, the image sensing member is configured to capture a movement of the carrier to capture a position of the carrier.

19. The desoldering equipment of claim 1, wherein the desoldering equipment further comprises a code scanning member, the code scanning member is arranged on a side of the conveying assembly and configured to identify the mainboard.
